(19) United States
(12) Patent Application Publication
(10) Pub. No.: US 2016/0143229 A1
(43) Pub. Date: May 26, 2016

(54) ARRANGEMENT FOR WINE OR FRUIT GROWING

(71) Applicant: VOESTALPINE KREMS GMBH, Krems an der Donau (AT)

(72) Inventors: Alfred Seyr, Statzendorf (AT); Christian Hauser, Wien (AT); Hans Pflügl, Rohrendorf (AT); Matthias Stumvoll, Weissenkirchen (AT)

(21) Appl. No.: 14/897,786

(22) PCT Filed: Jun. 11, 2014
(86) PCT No.: PCT/EP2014/062161

§ 371 Date: Dec. 11, 2015

(30) Foreign Application Priority Data
Jun. 11, 2013 (EP) 13171562.5

(51) Int. Cl. A01G 17/06

(52) U.S. Cl. CPC A01G 17/06; A01G 2017/065

(57) ABSTRACT

A device for wine or fruit growing, having at least one metallic trellis post and having at least one, in particular metallic, profile piece, which is fastened to the trellis post and has at least one holding element for a tensioning wire. In order to facilitate handling of the device and to increase its stability, the invention proposes providing a closed rectilinear guide between the trellis post and the profile piece, of which guide the trellis post forms, on the longitudinal side, a rail-like guide element on which the profile piece is guided in sliding fashion, and providing an open snap connection of which the profile piece has a spring element that engages with the trellis post M detent fashion.

### TECHNICAL FIELD

The invention relates to a device for wine or fruit growing having at least one metallic, trellis post and having at least one, in particular metallic, profile piece, which is fastened to the trellis post and has at least one holding element for a tensioning wire.

### BACKGROUND OF THE INVENTION

In order to be able to provide a trellis post with holding elements for a tensioning wire at a freely selectable trellis height, it is known from the prior art (CH699287A2) to provide the holding elements on a metal profile that is fastened to the trellis post by means of a screw connection, The two profile legs at the ends of the metal profile are embodied in the form of claws in order to exert a clamping action on the trellis post and thus increase the strength of the mechanical connection. Such a load-resistant connection between the trellis post and tensioning wire is particularly advantageous if the device is placed under mechanical stress by a harvesting operation—e.g. by a harvesting, machine. Disadvantageously, however, the claws of the metal profile cause damage to the surfaces of the trellis post, which can also reduce its corrosion resistance and thus the stability of the device.

Also known from the prior art is a bent wire element (EP72420B1), which is supported on the trellis post in sliding fashion and whose one wire section engages in detent fashion in a stamped profile indentation of the trellis post. In addition, the wire element has a tab-shaped holding element for threading the tensioning wire into place. These wire elements do in fact permit an easy-to-use height adjustment on the trellis post, even with the tensioning wire already threaded into place, but because of their spring-elastic property, it is not possible to thus assure a load-resistant connection—in fact, particularly when transverse forces act on the tensioning wire and thus exert a tilting action on the wire elements. A considerable amount of such transverse forces, however, must be expected among other things with the use of harvesting machines. Detached, wire elements, however, represent a problem for the function of harvesting machines, which is why such devices have only limited suitability for automated wine or fruit growing.

### SUMMARY OF THE INVENTION

The object of the invention, therefore, is to modify the design of a device for wine or fruit growing of the type explained at the beginning so as to enable an easy-to-use height adjustment of the tensioning wire on the trellis post without thereby reducing the stability of the device.

The invention attains the stated object in that between the trellis pest and the profile piece by providing a closed rectilinear guide, of which the trellis post forms, on the longitudinal side, a rail-like guide element on which the profile piece is guided in sliding fashion and providing an open snap connection, of which the profile piece has a spring element, which engages with the trellis post in detent fashion.

If between the trellis post and the profile piece, a closed rectilinear guide is provided, of which the trellis post forms, on the longitudinal side, a rail-like guide element on which the profile piece is guided in sliding fashion, then not only is it possible to incorporate into the trellis post the advantage of a sliding support that is known from bent wire elements, it is particularly also possible to ensure a high stability of the device. It is thus possible, in comparison to the prior art, to dispense with claws or the like on the profile piece in order to thus improve the mechanical connection between the trellis post and the profile piece. This also makes it possible to avoid damaging the trellis post. in addition, thanks to the increased flexural rigidity of the profile piece in comparison to wire elements, taking into account its closed rectilinear guide, it is possible to achieve a connection that is particularly load-resistant from a mechanical standpoint, which can reliably prevent the profile piece from lifting up from trellis post, even with comparatively high tilting loads. It is therefore no longer necessary to reckon with detached profile pieces and the attendant complications, even when transverse loads are exerted by harvesting machines, so that the device according to the invention can be particularly suitable for automated wine or fruit growing. If in addition, an open snap connection is provided between the trellis post and the profile piece, of which the profile piece has a spring element that engages with the trellis post in detent fashion, then this can significantly facilitate the height adjustment of the tensioning, wire. Furthermore, no additional fasteners are required to fix the profile piece in position, which not only can simplify the design and maintenance, but also can as a further result reduce the risk of parts of the device coming loose, thus further increasing the suitability of the device for automated wine or fruit growing.

If the profile piece has a spring element in the form of a protruding snap hook, which engages in detent fashion in a profiled region or opening in the trellis post, then this can further facilitate the handling of the device, in particular, however, the protruding design of the snap hook makes it possible to dispense with hand tools for actuating the snap connection. This also ensures a high stability of the trellis post—in particular on its surface.

In a structurally simple way, a snap hook can be embodied in the form of a bent sheet metal part.

If the snap hook is composed of a tab of the profile piece, then it is possible to reduce the manufacturing expense of the profile piece and also produce a mechanically load-resistant structural composite.

An unwanted lifting of the profile piece from the trellis post can be significantly impeded if at least two profile legs of the profile piece constitute wraparound guide surfaces of the rectilinear guide. In addition, a wraparound guide of this kind can also reduce the risk of the profile piece tilting when it is slid on the trellis post. It is thus also possible to avoid mechanical strains on the trellis post surfaces, which in turn increases its stability. Preferably, the profile legs at the end of the profile piece constitute these wraparound guide surfaces in order to minimize the material requirements of the profile piece.

The profile piece can additionally have a profile section that protrudes from the trellis post and has at least one profile opening that constitutes at least a part of the holding element for the tensioning wire in order to thus be able—in a comparatively simply designed way—to provide the profile piece with means for guiding or holding the tensioning wire.

Simple production conditions can be achieved if the profile section has a U-shaped cross-section. it is thus possible to achieve the manufacture by means of inexpensive shaping methods.

If the profile opening has at least two slots that are at an angle relative to each other, then it is also possible for the accommodated tensioning wire to be provided on the holding element—with improved protection from an undesired withdrawal in particular, slot sections that extend normally to each other have proven useful in order to be able to ensure maximum prevention of withdrawal from the holding element, even if there are vibrations in the tensioning wire.

A reduced design complexity can also be produced if the profile opening extends in a T shape.

The tensioning wire can be additionally protected against unwanted unhooking from the profile piece if the slot that opens out onto the spine of the protruding profile section feeds into slot sections of the other slot at different slot heights, which are provided as slot sections on each of the two legs of the protruding profile section.

Preferably, a profile opening, that is provided on the spine of the protruding profile section and opens out at an angle to the rectilinear guide can achieve the fact that when hanging the tensioning wire in position, it can be tilted and as a result, a tensile strain must be exerted on it. The risk of an unwanted unhooking of the tensioning wire can be reduced as a result, which increases the stability of the device. In addition, this form can make it possible to provide profile openings of different depths on a holding element,

The distance between the tensioning wire and trellis post can be adjusted with comparative ease by means of the profile piece if the protruding profile section has at least two profile openings with different depths. The distance between the slots of different depths can be selected in accordance with the required normal distance from the trellis post. In addition, adjusting this distance does not absolutely require the profile piece to be slid on the trellis post, which can facilitate the use of the device.

To benefit from cost advantages, the profile piece can be composed of a shaped piece of sheet metal. A contribution to this can be made in particular by a profiled roller being used for a shaping process.

Tensioning wires extending on both sides of the trellis post can be fastened to the device in a height-adjustable way if opposite sides of the trellis post are each provided with at least one profile piece that is guided in sliding fashion.

### BRIEF DESCRIPTION OF THE DRAWINGS

The figures show the subject of the invention by way of example in conjunction with an embodiment variant, in the drawings

FIG. 1 is a broken, partially cut-away front view of the device for wine of fruit growing,

FIG. 2 is a partially cut-away top view of the device according to FIG. 1,

FIG. 3 is a broken, partially cut-away side view of the device according to FIG. 1,

FIG. 4 is an enlarged detail view from FIG. 1, and

FIG. 5 is an enlarged detail view from FIG. 3.

### DETAILED DESCRIPTION OF THE PREFERRED EMBODIMENTS

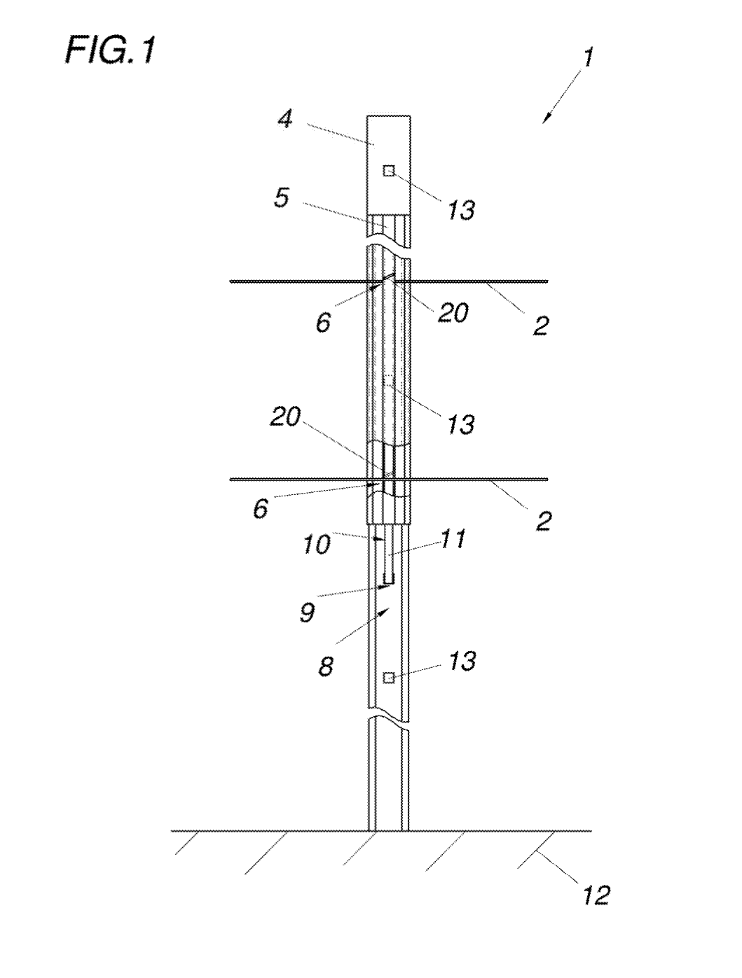

The device 1 that is shown in a broken and partially cut-away side view in FIG. 1 is intended for wine or fruit growing. For example, vine tendrils wrap around the tensioning wires 2, 3 of the device 1 in order to provide support to a grape vine, not shown, as it grows. These therefore mechanically stressed tensioning wires 2 are supported by a plurality of successive trellis posts 4 situated one after another, of which only one trellis post 4, which is anchored in the soil 12, is shown in FIG. 1 for the sake of clarity.

In the mechanical flow of force between the trellis post 4 and the tensioning wire 2, a profile piece 5 is provided, which has a holding element 6 for each tensioning wire 2. The profile piece 5 is made of a shaped piece of metallic sheet, in particular sheet steel, and preferably has an anticorrosion layer. The profile piece 5 can be positioned at different vertical heights of the trellis post 4 by means of a closed rectilinear guide 7 according to the invention, which reliably prevents the profile piece 5 from lifting up from the trellis post 3. For this reason, even harvesting machines cannot jeopardize the mechanical connection between the tensioning wires 2, 3, the profile piece 5, and the trellis post 4, which makes the device 1 according to the invention particularly suitable for automated wine or fruit growing. Of this rectilinear guide 7, the trellis post 4 forms the tail-like guide element 8, which extends along the trellis post 4. The profile piece 5 is guided on the rail-like guide element 8 in sliding fashion, forming a linear guide. A snap connection 9 fixes the profile piece 5, 25 in position on the trellis post 4. For this purpose, the profile piece 5 is associated with a spring element 10 that engages with the trellis post 4 in detent fashion. The combination of the rectilinear guide 7 or linear guide and the snap connection 9 also ensures that the surface of the trellis post 4 is not damaged during adjustment of the position of the profile piece 5. The advantages of a corrosion-protected trellis post 4 are thus retained.

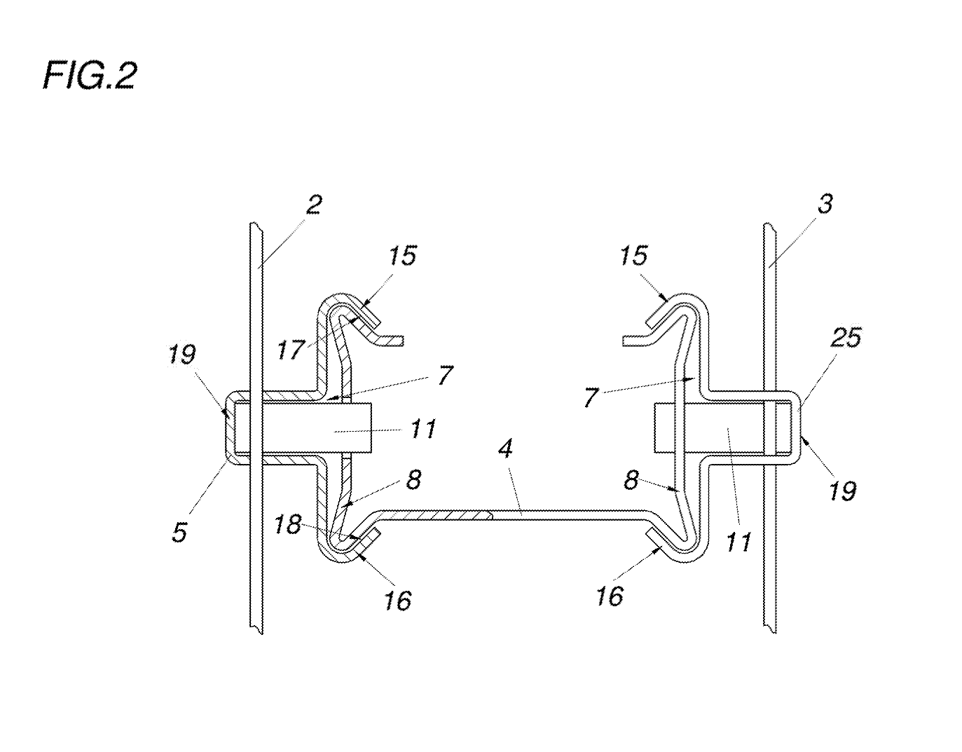

The spring element 10 of the profile piece 5 is embodied in the form of a snap hook 11 that protrudes from the profile piece 5. Such a protruding embodiment facilitates the opening of the snap connection 9, which further reduces the probability of damage to the trellis post 4, for example caused by hand tools. As is shown in FIGS. 1 and 2, the snap hook 11 engages in detent fashion in one of the openings 13 of the trellis post 4. instead of the openings 13, it is also conceivable to provide stamped indentations in the trellis post 4 with the aid of a shaping process, which has not, however, been depicted in detail.

The snap hook 11 is embodied in the form of a bent Sheet metal part 14, which facilitates the manufacture of the profile piece 5, particularly because the snap hook 11 is composed of a tab of the profile piece 5. This achieves a device I that is inexpensive to produce.

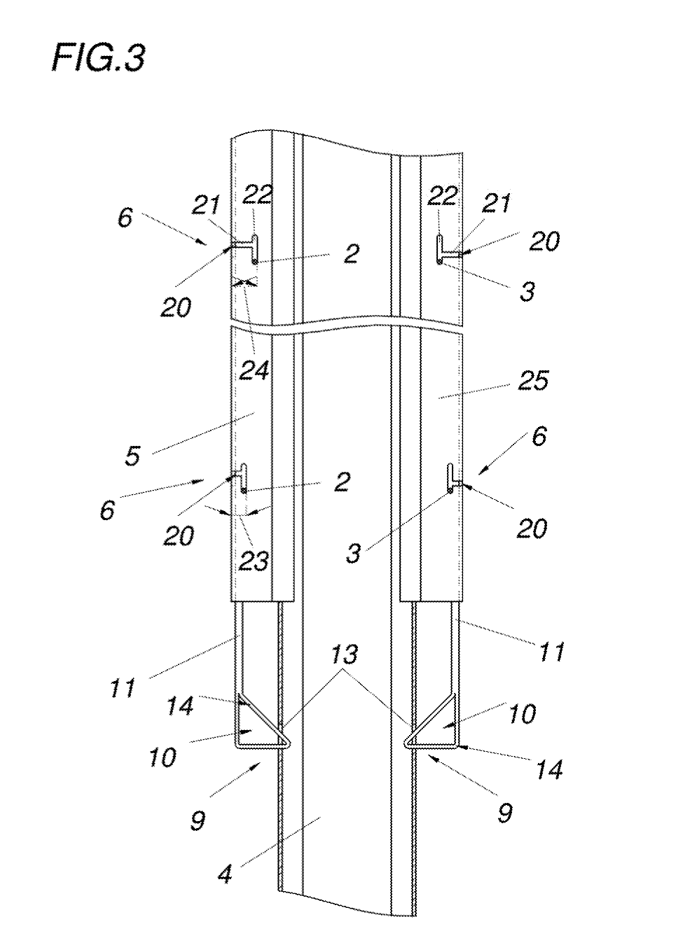

A broad contact of the profile piece 5, 25 on the trellis post 4 is provided in that two profile legs 15, 16 of the profile piece 5 constitute wraparound guide surfaces 17, 18 for the rectilinear guide 7—as can be seen in FIG. 3, for example. For this purpose, the ends of the profile piece 5 are used to embody the profile legs 17, 18 in a material-saving way, giving the profile piece 5 an essentially U-shaped, cross-section.

The holding element 6, which is provided for a multitude of different tensioning, wires 2 on the profile piece 5, is composed of the profile piece 5 itself, which significantly reduces the structural complexity of the device 1. For this purpose, a U-shaped profile section 19 that protrudes from the trellis post 4 is provided on the profile piece 5 produced, for example, by means of a shaping process. Openings 20 are provided in this profile section 19, which serve to hold the tensioning wire 2,

The openings 20 are composed of two slot sections 21, 22 that are oriented normally to each other, which give the opening a T-shaped form. This reduces the risk of the tensioning wire 2 coming unhooked, even if it is vibrating,

As is also clear in FIG. 3, the openings 20 have different depths 23, 24 in the protruding profile section 19, permitting the normal distance of the tensioning wires 2 from the trellis post 4 to be changed.

In addition, two profile pieces 5, 25 are supported in sliding fashion on the broad sides of the trellis post 4, in order to thus fasten tensioning wires 2, 3 to both sides of the trellis post 4. The structural embodiment of the two profile pieces 5, 25 and of their supports on the trellis post 4 is identical.

It is, however, also conceivable to provide profile pieces 5, 25 that are different from each other in order, for example, to be able to satisfy the need for a wide variety of distances between the tensioning wire 2, 3 and the trellis post 4.

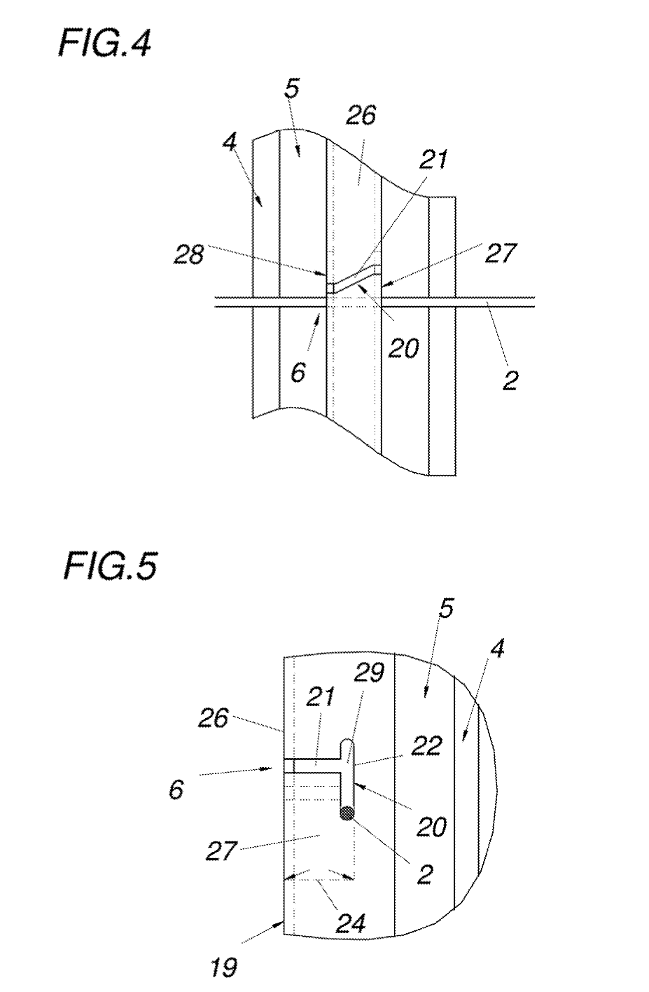

FIGS. 4 and 5 show enlarged images of the profile opening 20. The first slot 21 of this profile opening 20 opens out onto the spine 26 of the protruding profile section 19 and the tensioning wire 2 can be guided into the holding element 6 of the profile piece through it. This first slot 21 is connected to the second slot 22, which has slot sections 29 in both legs 27, 28 of the protruding profile section 19. As can be seen particularly in FIG. 5, the slot 21 feeds into the slot section 29 on the leg 27 higher than is the case with the slot section 29 on the leg 28. This prevents unwanted unhooking of the tensioning wire 2 from the holding element 6.

FIG. 4 also shows that the profile opening 20 on the spine 26 of the protruding profile section 19 opens out at an angle relative to the rectilinear guide 7. in order to be able to insert, the tensioning wire 2 into the holding element. 6, the tensioning wire 2 must therefore be tilted and thus tensioned. This further increases the reliability of the holding element 6 in preventing an unwanted unhooking of the tensioning wire 2.

1. A device for wine or fruit growing, comprising:
at least one metallic trellis post;
at least one metallic profile piece, which is fastened to the trellis post and has at least one holding element for a tensioning wire; and
a closed rectilinear guide positioned between the trellis post and the profile piece, wherein the trellis post forms, on a longitudinal side of the guide, a rail-like guide element on which the profile piece is guided in sliding fashion, and the profile piece has a spring element that engages with the trellis post in detent fashion to provide an open snap connection.

2. The device according to claim 1, wherein the profile piece comprises a spring element in the form of a protruding snap hook, which engages in detent fashion in a profiled region or opening in the trellis post.

3. The device according to claim 2, wherein the snap hook is embodied in the form of a bent sheet metal part.

4. The device according to claim 2, wherein the snap hook is composed of a tab of the profile piece.

5. The device according to claim 1, wherein at least two profile legs at the ends of the profile piece, constitute wraparound guide surfaces of the rectilinear guide.

6. The device according to claim 1, wherein the profile piece has a profile section protruding from the trellis post, with at least one profile opening, which constitutes at least a part of the holding element for the tensioning wire.

7. The device according to claim 6, wherein the profile section has a U-shaped cross-section.

8. The device according to claim 6, wherein the profile opening has at least two slots that are oriented at an angle to each other.

9. The device according to claim 8, wherein the profile opening extends in a T shape.

10. The device according to claim 8, wherein a slot that opens out onto the a spine of the protruding, profile section feeds into slot sections of the other slot at different slot heights, which are provided as slot sections on each of the two legs of the protruding profile section.

11. The device according to claim 10, wherein the profile opening provided on the spine of the protruding profile section opens out at an angle to the rectilinear guide.

12. The device according to claim 6, wherein the protruding profile section has at least two profile openings with different depths.

13. The device according to claim 1, wherein the profile piece is composed of a shaped, profile-rolled, piece of sheet metal.

14. The device according to claim 1, wherein opposite sides of the trellis post are each provided with at least one profile piece that is guided in sliding fashion.
